(19) United States
(12) Patent Application Publication
(10) Pub. No.: US 2024/0211488 A1
(43) Pub. Date: Jun. 27, 2024

(54) TRANSACTION COMMITMENT SYSTEMS, METHODS, AND APPARATUSES BASED ON DISTRIBUTED DATABASE SYSTEMS

(71) Applicant: Beijing OceanBase Technology Co., Ltd., Beijing (CN)

(72) Inventors: Fusheng HAN, Beijing (CN); Huafeng Xi, Beijing (CN); Jinliang Xiao, Beijing (CN); Shanyan Gao, Beijing (CN)

(73) Assignee: Beijing OceanBase Technology Co., Ltd., Beijing (CN)

(21) Appl. No.: 18/521,444

(22) Filed: Nov. 28, 2023

(30) Foreign Application Priority Data
Dec. 22, 2022 (CN) 202211654866.5

(51) Int. Cl. G06F 16/27; G06F 16/23

(52) U.S. Cl. CPC G06F 16/273; G06F 16/2379

(57) ABSTRACT

This specification provides transaction commitment systems, methods, and apparatuses based on distributed database systems, including: a transaction coordinator and transaction participants of a target transaction, where each transaction participant records a demarcation location. The transaction participant is configured to: generate a preparation log in response to a preparation request initiated by a transaction coordinator for the target transaction, persistently storing the preparation log, returning a persistence result to the transaction coordinator, in response to a transaction execution request initiated by the transaction coordinator, performing a transaction operation corresponding to the transaction execution request, and switching the target transaction from an unsettled state to a settled state after the transaction execution is completed, wherein the transaction execution request is generated by the transaction coordinator based on persistence results corresponding to the transaction participants.

### CROSS-REFERENCE TO RELATED APPLICATIONS

This application claims priority to Chinese Patent Application No. 202211654866.5, filed on Dec. 22, 2022, which is hereby incorporated by reference in its entirety.

### TECHNICAL FIELD

This specification relates to the field of distributed transaction processing technologies, and in particular, to transaction commitment systems, methods, and apparatuses based on distributed database systems.

### BACKGROUND

Data in a distributed database system are not stored in one machine, but are dispersedly stored in a plurality of nodes that are connected by using a computer network and the data are logically and centrally managed by a corresponding management system. Therefore, a database in the distributed database system is more advantageous over a conventional centralized database in terms of reliability, availability, scalability, etc., and is more applicable to scenarios such as various highly concurrent access and massive data processing in a network.

In a related technology, the distributed database system performs a corresponding data operation based on a transaction mechanism. Each transaction has two corresponding roles: a transaction coordinator and a transaction participant, and the two roles coordinate with each other to ensure correct implementation of the above-mentioned data operation. However, a coordination process between the transaction coordinator and the transaction participant is complex, and overall efficiency of transaction processing is low.

### SUMMARY

In view of the above-mentioned description, this specification provides transaction commitment systems, methods, and apparatuses based on distributed database systems, so as to overcome a disadvantage in a related technology.

Specifically, this specification is implemented using the following technical solutions:

According to a first aspect of some embodiments of this specification, a distributed database system is provided, including a transaction coordinator and transaction participants of a target transaction, where each transaction participant records a demarcation location, and the demarcation location is used to represent that in a transaction sequence formed by transactions that are processed by corresponding transaction participants, transactions preceding the demarcation location are all in a settled state; the transaction coordinator is configured to: initiate a preparation request for the target transaction to the transaction participant such that the transaction participant generates and persistently stores a corresponding preparation log; and initiate a corresponding transaction execution request to the transaction participant based on persistence results returned by all transaction participants for the preparation log; and the transaction participant is configured to: generate a corresponding preparation log in response to the preparation request, persistently store the preparation log, and return a persistence result to the transaction coordinator; and perform a transaction operation corresponding to the transaction execution request in response to the transaction execution request, and switch the target transaction from an unsettled state to a settled state after the execution is completed.

According to a second aspect of some embodiments of this specification, a transaction commitment method based on a distributed database system is provided, and is applied to transaction participants of a target transaction in the distributed database system, where each transaction participant records a demarcation location, and the demarcation location is used to represent that in a transaction sequence formed by transactions that are processed by corresponding transaction participants, transactions preceding the demarcation location are all in a settled state; and the method includes: generating a corresponding preparation log in response to a preparation request initiated by a transaction coordinator for the target transaction; persistently storing the preparation log and returning a persistence result to the transaction coordinator; and in response to a transaction execution request initiated by the transaction coordinator, performing a transaction operation corresponding to the transaction execution request, and switching the target transaction from an unsettled state to a settled state after the execution is completed, where the transaction execution request is generated by the transaction coordinator based on persistence results corresponding to all transaction participants.

According to a third aspect of some embodiments of this specification, a transaction commitment method based on a distributed database system is provided, and is applied to a transaction coordinator of a target transaction in the distributed database system, where the method includes: initiating a preparation request for the target transaction to transaction participants such that the transaction participants generate a corresponding preparation log, where each transaction participant records a demarcation location, and the demarcation location is used to represent that in a transaction sequence formed by transactions that are processed by corresponding transaction participants, transactions preceding the demarcation location are all in a settled state; and initiating a corresponding transaction execution request to all transaction participants based on persistence results that are returned by the transaction participants for the preparation log such that the transaction participants perform a transaction operation corresponding to the transaction execution request, and switch the target transaction from an unsettled state to a settled state after the execution is completed.

According to a fourth aspect of some embodiments of this specification, a transaction commitment apparatus based on a distributed database system is provided, and is applied to transaction participants of a target transaction in the distributed database system, where each transaction participant records a demarcation location, and the demarcation location is used to represent that in a transaction sequence formed by transactions that are processed by corresponding transaction participants, transactions preceding the demarcation location are all in a settled state; and the apparatus includes: a preparation log generation unit, configured to generate a corresponding preparation log in response to a preparation request initiated by a transaction coordinator for the target transaction; a preparation log persistence unit, configured to persistently store the preparation log and return a persistence result to the transaction coordinator; and a transaction operation execution unit, configured to: in response to a transaction execution request initiated by the transaction coordinator, perform a transaction operation corresponding to the transaction execution request, and switch the target transaction from an unsettled state to a settled state after the execution is completed, where the transaction execution request is generated by the transaction coordinator based on persistence results corresponding to all transaction participants.

According to a fifth aspect of some embodiments of this specification, a transaction commitment apparatus based on a distributed database system is provided, and is applied to a transaction coordinator of a target transaction in the distributed database system, where the apparatus includes: a preparation request initiation unit, configured to initiate a preparation request for the target transaction to transaction participants such that the transaction participants generate a corresponding preparation log, where each transaction participant records a demarcation location, and the demarcation location is used to represent that in a transaction sequence formed by transactions that are processed by corresponding transaction participants, transactions preceding the demarcation location are all in a settled state; and an execution request initiation unit, configured to initiate a corresponding transaction execution request to all transaction participants based on persistence results that are returned by the transaction participants for the preparation log such that the transaction participants perform a transaction operation corresponding to the transaction execution request, and switch the target transaction from an unsettled state to a settled state after the execution is completed.

According to a sixth aspect of some embodiments of this specification, a computer-readable storage medium is provided, where the computer-readable storage medium stores a computer program, and the program is executed by a processor to implement the steps of the method according to the second aspect and the third aspect.

According to a seventh aspect of some embodiments of this specification, an electronic device is provided, including a memory, a processor, and a computer program that is stored in the memory and that can run on the processor, where the processor executes the program to implement the steps of the method according to the second aspect and the third aspect.

In the technical solutions provided in this specification, a part of a process of persistently storing a log by a transaction coordinator and a transaction participant in the related technology is cancelled, and system resource overheads are reduced. In addition, the transaction participant is configured to correspondingly record a demarcation location for determining a settled transaction, so as to ensure that a transaction still has a status restoration capability in the case of an abnormality.

It should be understood that the above-mentioned general description and the following detailed description are merely examples and explanations, and should not limit this specification.

### BRIEF DESCRIPTION OF DRAWINGS

To describe the technical solutions in some embodiments of this specification or in a conventional technology more clearly, the following briefly describes the accompanying drawings needed for describing some embodiments or the conventional technology. Clearly, the accompanying drawings in the following description merely show some embodiments of this specification, and a person of ordinary skill in the art can still derive other drawings from these accompanying drawings.

FIG. 1 is a schematic diagram illustrating a relationship between a transaction coordinator and a transaction participant, according to some example embodiments of this specification;

FIG. 2 is a schematic interaction diagram illustrating two-phase commitment based on a distributed database system, according to some example embodiments of this specification;

FIG. 3 is a schematic diagram illustrating another transaction commitment system based on a distributed database system, according to some example embodiments of this specification;

FIG. 4 is a schematic diagram illustrating still another transaction commitment system based on a distributed database system, according to some example embodiments of this specification;

FIG. 5 is a schematic flowchart illustrating a transaction commitment method based on a distributed database system, according to some example embodiments of this specification;

FIG. 6 is a schematic flowchart illustrating another transaction commitment method based on a distributed database system, according to some example embodiments of this specification;

FIG. 7 is a schematic structural diagram illustrating an electronic device, according to some example embodiments of this specification;

FIG. 8 is a schematic structural diagram illustrating a transaction commitment apparatus based on a distributed database system, according to some example embodiments of this specification; and

FIG. 9 is a schematic structural diagram illustrating another transaction commitment apparatus based on a distributed database system, according to some example embodiments of this specification.

### DESCRIPTION OF EMBODIMENTS

Some example embodiments are described in detail here, and examples of the example embodiments are presented in the accompanying drawings. When the following description relates to the accompanying drawings, unless specified otherwise, the same numbers in different accompanying drawings represent same or similar elements. Implementations described in the following example embodiments do not represent all implementations consistent with this specification. On the contrary, the implementations are merely examples of apparatuses and methods that are consistent with some aspects of this specification.

The terms used in this specification are merely for illustrating some specific embodiments, and are not intended to limit this specification. The terms “a” and “the” of singular forms used in this specification are also intended to include plural forms, unless otherwise specified in the context clearly. It should be further understood that the term “and/or” used in this specification indicates and includes any or all possible combinations of one or more associated listed items.

It should be understood that although terms “first”, “second”, “third”, etc. may be used in this specification to describe various types of information, the information should not be limited by these terms. These terms are used merely to differentiate information of the same type. For example, without departing from the scope of this specification, first information can also be referred to as second information, and similarly, the second information can also be referred to as the first information. Depending on the context, for example, the word “if” used here can be interpreted as “while”, “when”, or “in response to determining”.

In a related technology, databases can be classified into a disk database and a memory database based on different storage architectures. The disk database stores data on a disk. However, because of quite low read/write performance of the disk, in the case of a large data volume and frequent disk access operations, a data processing speed of the disk database is low. The memory database fully loads data into the memory for processing. Since the memory is a quite high-speed storage medium relative to a disk, the memory database has no disk read/write performance bottleneck like the above-mentioned disk database, and provides a higher data processing speed. On the basis of the disk database and the memory database, a quasi-memory database can be further derived. To be specific, the entire database stores baseline data by using a non-volatile memory (usually a solid state disk (SSD)) as a carrier. However, all modified data are defined as incremental data, and can be written into a memory only. As such, newly added, deleted, or modified data (modified increments) are all stored in the memory. Therefore, it can also be considered that a data manipulation language (DML) corresponding to the above-mentioned quasi-memory database is a complete memory operation with high performance. However, when the incremental data of the memory satisfy a specific condition, dumping (minor freeze) or merging (major freeze) between the incremental data and the baseline data can also be triggered.

Certainly, regardless of which database type described above is used, a corresponding database system needs to ensure that a corresponding transaction features atomicity, consistency, isolation, and durability (ACID). The atomicity represents that all operations in one transaction are completed, or none of the operations is completed, and the transaction does not terminate at a specific intermediate phase. Once an error occurs on the transaction during execution, the transaction is restored (also referred to as rollback) to a state before the transaction starts, as if the transaction had never been executed. Complexity of ensuring the atomicity of the transaction mostly comes from abnormality handling such as recovery from downtime and active/standby switchover. For example, two rows of data are modified for a transaction. If a machine that executes the transaction is shut down after the first row is modified and before the second row is modified, without assurance from other mechanisms, after the machine recovers a service, only the modification of the first row remains in the system, which certainly does not satisfy the above-mentioned atomicity requirement.

In a database system, the above-mentioned atomicity is generally implemented by using a logging technology. When a log is used, operations of an entire transaction can be first encoded into continuous log information, and then the log information can be persistently stored in a non-volatile memory. Successful persistence of the log information represents that atomicity of the transaction is successfully ensured. Further, after an abnormality such as recovery from downtime occurs, if a log of a specific transaction is determined to be incomplete, it can be determined that not all operations corresponding to the transaction are completed, and therefore, a rollback operation can be directly performed on the transaction.

When a database includes a plurality of machines, a database system corresponding to the database can be considered as a distributed database system, and each machine can have its own log as a node of the distributed database system. If a transaction includes a plurality of nodes, a corresponding log is written on each of the plurality of nodes, and such a transaction can be referred to as a “distributed transaction”. However, for the distributed transaction described above, if a specific node of the distributed transaction recovers from downtime and restores a transaction status from a log, it is also necessary to ask all nodes to determine whether all logs of the transaction described above succeed in persistence. However, in an actual application scenario, resource overheads and operation delays caused by performing multi-node communication for each transaction when the transaction status is restored each time cannot be withstood. Therefore, the above-mentioned distributed transaction can use a synchronization protocol like two-phase commitment (2PC) to ensure atomicity.

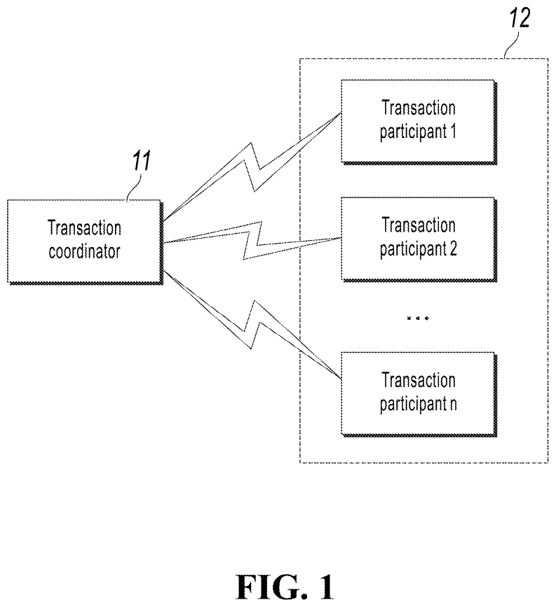

Before the above-mentioned 2PC protocol is described, a relationship between the above-mentioned transaction coordinator and the above-mentioned transaction participant is further explained with reference to FIG. 1. FIG. 1 is a schematic diagram illustrating a relationship between a transaction coordinator and a transaction participant, according to some example embodiments of this specification. As shown in FIG. 1, the system can include a transaction coordinator 11 and a transaction participant 12.

As an entity that drives any transaction commitment procedure in the distributed database system, the transaction coordinator 11 can be implemented on any node, or certainly can be implemented on the same node as any transaction participant. During running of the system, the transaction coordinator 11 can promote the transaction participant 12 to perform a transaction operation such that data consistency is maintained when all transaction participants corresponding to the transaction perform transaction commitment.

The transaction participant 12 assumes a commitment task for transaction data modification, and a plurality of transaction participants can be correspondingly associated with one transaction coordinator 11 at the same time. For example, the transaction coordinator in FIG. 1 is associated with n transaction participants (i.e., a transaction participant 1, a transaction participant 2, . . . , and a transaction participant n, where n is a positive integer). Each node can generally implement one transaction participant. Certainly, there is a case in which one node implements a plurality of transaction participants. 1. When a plurality of data tables of any node relate to one transaction, and each data table has a plurality of replicas, the above-mentioned one transaction can be considered as a distributed transaction, and each data table can be considered as one transaction participant in the node. 2. When a data volume of a data table is excessively large, the table can be split into a plurality of partitions such that different data are respectively stored in corresponding partitions. In such case, when the above-mentioned distributed database system supports a partitioning function and a plurality of partitions are configured in at least one node, the plurality of partitions relate to one transaction, and each partition has a plurality of replicas, the above-mentioned one transaction can be considered as a distributed transaction, and each partition table can be considered as one transaction participant in the node. A relationship between a replica and a distributed database system is described below, and details are omitted here in this specification for simplicity.

A connection method between the transaction coordinator 11 and the transaction participant 12 can include a plurality of types of wired or wireless connections, which is not limited in this specification.

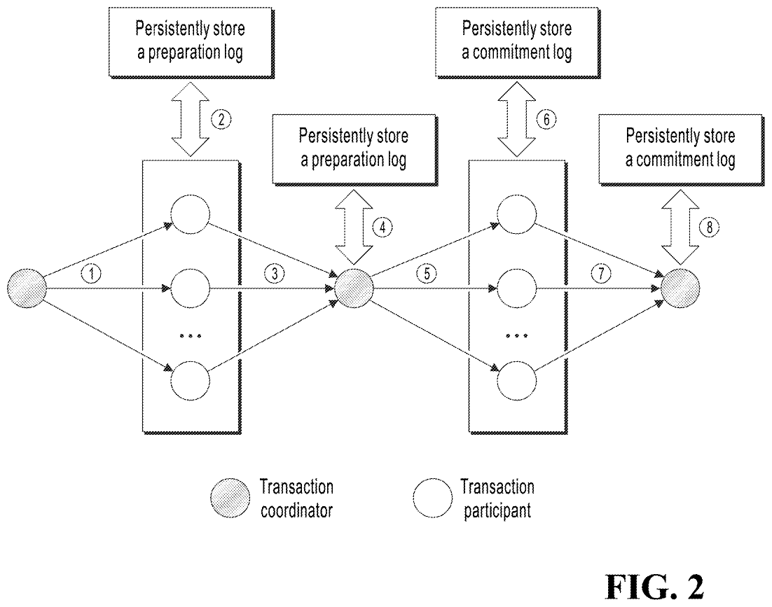

As described above, in the distributed transaction, when any node recovers from downtime, it is impractical to ask all nodes to determine persistence results of all logs of the transaction. Therefore, a consistency protocol like the above-mentioned 2PC can be introduced to ensure that data consistency is maintained when all nodes in the distributed system architecture perform transaction commitment. Specifically, the above-mentioned 2PC protocol divides the transaction commitment process into two phases: a commitment request phase and a commitment execution phase (or referred to as a PREPARE/preparation/voting phase and a “COMMIT/ABORT”/commitment/execution phase), which thus is referred to as two-phase commitment. The following further explains some implementations of the 2PC with reference to FIG. 2. FIG. 2 is a schematic interaction diagram illustrating two-phase commitment based on a distributed database system, according to some example embodiments of this specification. As shown in FIG. 2, steps can be classified into the above-mentioned preparation phase and the above-mentioned execution phase based on an execution sequence.

Preparation phase: A transaction coordinator initiates a preparation request for a target transaction to all transaction participants (corresponding to step 1 in FIG. 2). After receiving a message, each transaction participant locally executes the above-mentioned target transaction, so as to determine whether the transaction can be committed. If the transaction can be committed, the transaction participant persistently stores a corresponding preparation log (corresponding to step 2 in FIG. 2). After the persistence succeeds, the transaction participant returns a persistence result representing a success to the transaction coordinator; otherwise, the transaction participant returns a persistence result representing a failure (corresponding to step 3 in FIG. 2). After receiving messages of all transaction participants, the transaction coordinator can persistently store the corresponding preparation log (corresponding to step 4 in FIG. 2). Compared to the above-mentioned preparation log persistently stored by the transaction participant, the preparation log persistently stored by the transaction coordinator records persistence results of all transaction participants. In other words, the preparation log of the transaction coordinator can be used to record transaction statuses of the target transaction in all transaction participants, and promote execution of the execution phase in the following description. A person skilled in the art can understand that logs generated by different types of databases are generally different from each other. Therefore, this specification describes only a conventional procedure of the protocol, and does not thoroughly analyze a specific log name or log content.

Execution phase: After receiving persistence results of all transaction participants, if all the persistence results represent a success, the transaction coordinator can determine that the above-mentioned target transaction can be committed. Otherwise, the transaction coordinator determines that the above-mentioned target transaction needs to be rolled back. Then, the transaction coordinator sends a transaction execution request (for example, a transaction commitment request or a transaction rollback request) to all transaction participants (corresponding to step 5 in FIG. 2). After receiving the above-mentioned transaction execution request, each transaction participant starts to persistently store a corresponding commitment log (or rollback log) (corresponding to step 6 in FIG. 2). After persistence of the above-mentioned commitment log is completed, the transaction participant returns a corresponding persistence result to the transaction coordinator, and releases a corresponding system resource (corresponding to step 7 in FIG. 2). After receiving all persistence results corresponding to the commitment log, the coordinator can persistently store the corresponding commitment log (corresponding to step 8 in

FIG. 2). Compared to the above-mentioned commitment log persistently stored by the transaction participant, the commitment log persistently stored by the transaction coordinator records persistence results of all transaction participants. In other words, the commitment log of the transaction coordinator can be used to record transaction statuses of the target transaction in all transaction participants. After persistence of the above-mentioned commitment log succeeds, the transaction coordinator releases the system resource and exits.

It can be understood that, in the case of compliance with the 2PC protocol, the transaction needs to cause time consumption for input/output (I/O) of at least two times of remote procedure call (RPC) (i.e., sending the above-mentioned preparation request and the above-mentioned transaction execution request) and at least four times of transaction logging (i.e., the transaction coordinator and the transaction participant each persistently store the above-mentioned preparation log and the above-mentioned commitment log once) from the commitment start to the commitment end. Based on the above-mentioned preparation log and the above-mentioned commitment log, the transaction status of the corresponding transaction before the restart upon shutdown can be provided for the transaction participant and/or the transaction coordinator after the restart, thereby ensuring that the transaction participant and/or the transaction coordinator can quickly restore the transaction status of the corresponding transaction. However, transaction commitment performance is a core of database performance, and a long time consumed by the commitment protocol means a longer lock holding time, a heavier I/O load, and more network communication. Therefore, how to optimize transaction commitment performance and improve a processing capability of a system while ensuring a transaction restoration capability starts to become a common difficult task faced by major Internet enterprises nowadays. Based on the above-mentioned description, this specification provides the following technical solutions to alleviate the above-mentioned problems.

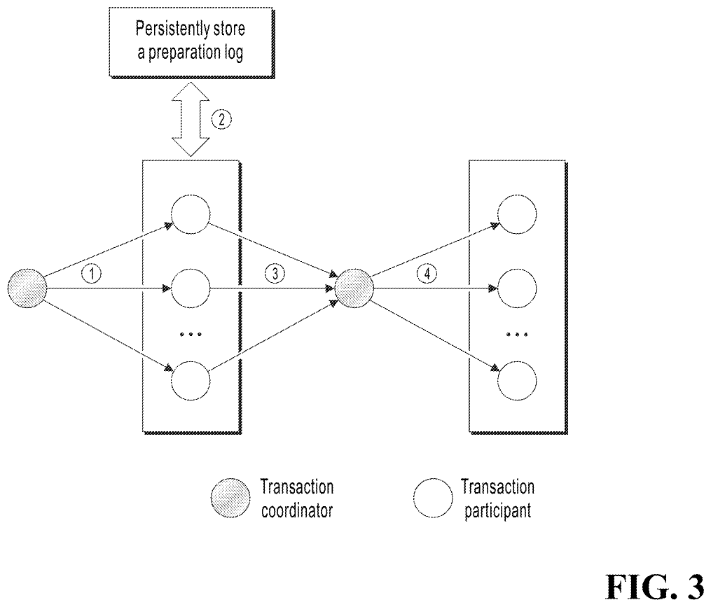

This specification implements a transaction commitment system based on a distributed database system. FIG. 3 is a schematic diagram illustrating another transaction commitment system based on a distributed database system, according to some example embodiments of this specification. As shown in FIG. 3, the above-mentioned distributed database system includes a transaction coordinator and transaction participants of a target transaction, where each transaction participant records a demarcation location, and the demarcation location is used to represent that in a transaction sequence formed by transactions that are processed by corresponding transaction participants, transactions preceding the demarcation location are all in a settled state.

The above-mentioned transaction sequence is maintained in a memory of a node on which a corresponding transaction participant is located. The transaction sequence describes a transaction related to the above-mentioned transaction participant and corresponding transaction information. Each piece of transaction information can include data such as a database operation sequence, a transaction version number, and a transaction execution status that are executed in the corresponding transaction. Based on an execution result of the transaction, the above-mentioned transaction execution status can be divided into five states: an active state, a partially committed state, a failed state, a committed state, and an aborted state. Based on a condition for determining whether the status is no longer changed, the transactions corresponding to the above-mentioned five states can be further classified into settled transactions (i.e., transactions in the committed state and the aborted state) and unsettled transactions (i.e., transactions in the active state, the partially committed state, and the failed state). Certainly, a related technology has disclosed specific definitions of the above-mentioned five states, and a switching condition and a switching operation between the states, and details are omitted here in this specification for simplicity.

As described above, databases can be specifically classified into a disk database, a memory database, and a quasi-memory database. When the above-mentioned distributed database system stores data based on the quasi-memory database, the data maintained by the above-mentioned distributed database system can include baseline data and incremental data generated for the above-mentioned baseline data. The baseline data are stored in a non-volatile memory, the incremental data are stored in a memory, and a transaction in the above-mentioned transaction sequence can correspond to the incremental data. When the above-mentioned distributed database system stores data based on the memory database, the data (including the transaction in the above-mentioned transaction sequence) maintained by the above-mentioned distributed database system can be stored in the memory. When the above-mentioned distributed database system stores data based on the disk database, although all the data maintained by the above-mentioned distributed database system are stored in the disk, to improve data storage efficiency, the disk database generally does not persistently store the data related to the settled transactions in the disk immediately, and instead, temporarily stores the data in the cache. Therefore, the transaction in the above-mentioned transaction sequence can also correspond to the data in the above-mentioned cache.

The above-mentioned transaction sequence can be maintained in the memory, which is a volatile memory. In addition, compared to 2PC, such a system includes only a persistence operation for a similar preparation log, and does not include a persistence operation for a commitment log. Therefore, when restart upon power loss or a similar situation occurs on the node on which the transaction participant is located, even if the preparation log in the following description is used to complete data playback and restore the above-mentioned transaction sequence, the restored transaction sequence still cannot determine whether each transaction is a settled transaction or an unsettled transaction before the power loss. In addition, in such case, each transaction is an unsettled transaction by default, and therefore, the above-mentioned transaction participant needs to execute a commitment procedure of each transaction again. Consequently, the transaction participant encounters a problem of an excessively long time for restart and restoration. In this specification, the above-mentioned problem can be effectively avoided by using the above-mentioned demarcation location. The above-mentioned demarcation location can be a transaction version number used to determine an execution sequence of a transaction. In such case, it is assumed that the above-mentioned transaction sequence is arranged in ascending order of the transaction version numbers, and a transaction with a smaller transaction version number is executed before a transaction with a larger transaction version number. Therefore, the largest transaction version number of the successively committed transactions on the transaction participant can be used as the above-mentioned demarcation location. As such, a transaction whose transaction version number is less than the demarcation location is determined as a settled transaction, and a transaction whose transaction version number is greater than the demarcation location is determined as an unsettled transaction. Compared to the cached transaction sequence, the above-mentioned demarcation location can be persistently stored. Therefore, when restart upon power loss or a similar situation occurs on the node on which the transaction participant is located, an unsettled transaction and a settled transaction in the restored transaction sequence can be determined based on the demarcation location, thereby further achieving an effect similar to the commitment log in the above-mentioned 2PC protocol. However, compared with the content of the above-mentioned commitment log, the demarcation location has an advantage of a small data volume, and therefore features a higher persistence speed and higher overall efficiency of transaction execution.

Compared to the schematic flowchart of two-phase commitment in FIG. 2, the system shown in FIG. 3 includes only a preparation phase (i.e., one-phase commitment). In such a phase, interaction operations between a transaction coordinator and a transaction participant of a target transaction in the distributed database system are as follows:

1. The transaction coordinator initiates a preparation request for the target transaction to the corresponding transaction participant.

When the above-mentioned distributed database needs to commit the above-mentioned target transaction, the transaction coordinator can initiate the preparation request to the corresponding transaction participant, and start to wait for a response (i.e., a persistence result in the following description) from each transaction participant node.

2. The transaction participant generates a corresponding preparation log in response to the preparation request, and persistently stores the preparation log.

Correspondingly any transaction participant that receives the above-mentioned preparation request, the transaction participant can first check a transaction permission, and after permission verification succeeds, perform all transaction operations until the preparation request is received, and persistently store the generated preparation log. Preparation logs generated by different types of databases are usually different. Typical disk databases such as MySQL and Oracle are used as an example. The preparation logs generated by such type of database can include an undo log and a redo log. However, for a memory database or a quasi-memory database similar to OceanBase (OB), the data of the above-mentioned target transaction before the above-mentioned preparation request is received are stored in the memory, and no actual modification is performed on the disk. Therefore, generating and persistently storing the above-mentioned undo log are of no practical significance. An actual function and specific content of the undo log and the redo log are basically disclosed in a related technology. Therefore, details are omitted here in this specification for simplicity.

As described above, to ensure data security and provide a highly available data service, data on each node can be physically stored in a plurality of copies, and each copy of data can be referred to as one replica. For example, when a data volume of a data table related to the target transaction is greater than a predetermined threshold, a plurality of replicas can be directly generated for each data table, or when the data related to the target transaction include partitions, a plurality of replicas can be generated for each partition. The above-mentioned replicas can be automatically scheduled and distributed by the system on a plurality of nodes based on a load and a specific policy, and the above-mentioned replicas support management operations such as migration, replication, addition, deletion, and type conversion. Further, in the above-mentioned distributed database system, to ensure data security of a partition or a data table corresponding to each transaction participant and provide a highly available data service, a replica mechanism can be introduced for the above-mentioned transaction participant.

In some embodiments, the above-mentioned transaction participant corresponds to a plurality of replicas in the above-mentioned distributed system. A process in which the above-mentioned transaction participant persistently stores the above-mentioned preparation log is equivalent to that the above-mentioned plurality of replicas each persistently store the above-mentioned preparation log. In addition, the above-mentioned persistence result is correlated with a proportion of replicas with successful persistence in the above-mentioned plurality of replicas. The above-mentioned proportion of replicas is merely a main basis for the above-mentioned plurality of replicas to determine the above-mentioned persistence result, and logic for determining the above-mentioned persistence result by using the basis needs to be distinguished based on an actual application scenario.

For example, the classic centralized database usually uses an active/standby synchronization solution. Such a solution specifically includes two synchronization modes: One mode is strong synchronization, in which each transaction operation in the active machine needs to be strongly synchronized to the standby machine to respond to the user. Such a mode can ensure that data are not lost when the server is faulty provided that normal execution of other services is suspended, and consequently, cannot ensure the availability. The other mode is asynchronization, in which each transaction operation only needs to be performed successfully on the active machine to respond to the user. Such a mode can ensure high availability, but causes data inconsistency between the active database and the standby database. Consequently, data are lost after the standby database is switched to become the active database. The active machine and the standby machine can be machines in which the master replica (leader) and the slave replica (follower) in the above-mentioned plurality of replicas are respectively located, and the active database and the standby database can be databases respectively corresponding to the master replica and the slave replica in the above-mentioned plurality of replicas. Meanings and functions of the master replica and the slave replica are further explained in the following description, and details are omitted here in this specification for simplicity. For the above-mentioned strong synchronization, the above-mentioned proportion of replicas can be considered as 100%. In other words, when all of the above-mentioned plurality of replicas succeed in persistence, the corresponding transaction participant can determine the above-mentioned persistence result as a success; otherwise, the above-mentioned persistence result is determined as a failure. For the asynchronization, the above-mentioned proportion of replicas can be considered as 1/m or higher, where m represents a total quantity of replicas corresponding to the above-mentioned transaction participant. In other words, when the master replica succeeds in persistence, the corresponding transaction participant can determine the above-mentioned persistence result as a success; otherwise, the above-mentioned persistence result is determined as a failure.

Certainly, the above-mentioned cases are all limited to a scenario in which a centralized database is used. In a scenario in which a distributed database is used, it can be ensured, based on a multi-replica consistency protocol, that data of one transaction participant on a plurality of replicas are consistent. The multi-replica consistency protocol based on a Paxos algorithm is used as an example. It is assumed that the above-mentioned transaction participant corresponds to one partition, and then a plurality of replicas corresponding to the partition can be automatically established as a Paxos group, and a master replica is automatically elected from the plurality of replicas. The above-mentioned multi-replica consistency protocol can define the above-mentioned transaction participant as follows: When at least half of replicas succeed in persistence, the above-mentioned persistence result is determined as a success; otherwise, the above-mentioned persistence result is determined as a failure. The above-mentioned proportion of replicas can be considered as 50% or higher. To avoid a case in which the replicas that succeed in persistence account for exactly half of the total quantity of replicas, the total quantity of replicas can generally be set to an odd number such as 3 or 5, which is not limited in this specification.

To facilitate distinguishing between specific operations of the master and slave replicas of the above-mentioned transaction participant for persistence of the above-mentioned preparation log, the following master node and slave node can be defined.

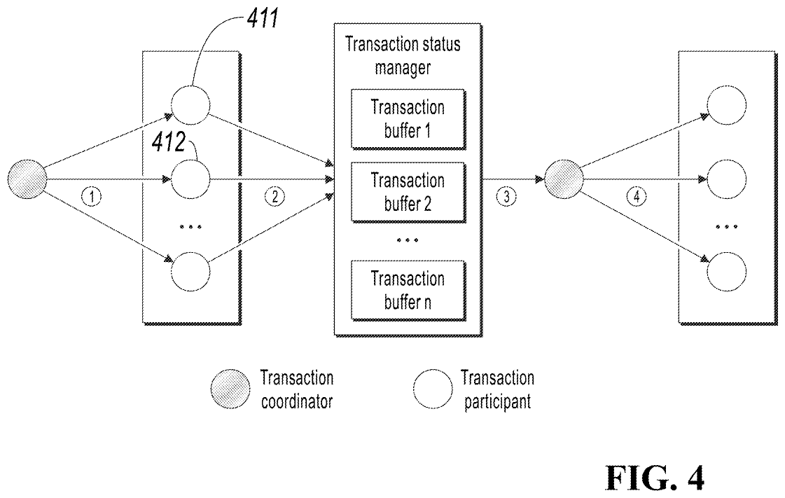

In some embodiments, the distributed database system includes a master node and one or more slave nodes, a master replica of any transaction participant is deployed on the master node, a slave replica of the any transaction participant is deployed on the one or more slave nodes, the master replica is used for data access, and the slave replica is used for data backup. When the transaction participant persistently stores the preparation log, the master replica can send the preparation log to a transaction status manager of the master node such that the transaction status manager writes the preparation log into a corresponding transaction buffer, and the transaction buffer persistently stores the written preparation log in the master replica and the slave replica. The transaction status manager is an actual object that maintains the transaction sequence of the transaction participant in the memory of the master node. These embodiments are further discussed below with reference to FIG. 4. Step 1 to step 4 in FIG. 4 are basically consistent with those in FIG. 3. A difference lies in that step 2 in FIG. 4 further supplements the description of the interaction between the transaction participant and the transaction status manager of the node on which the transaction participant is located during the persistence of the preparation log. As shown in FIG. 4, the plurality of transaction participants all correspond to the same node A. Therefore, the above-mentioned transaction status manager can include preparation logs respectively corresponding to the plurality of transaction participants. A transaction participant 411 is used as an example. It is assumed that a master replica of the transaction participant 411 is also deployed in the above-mentioned node A, and then the above-mentioned transaction status manager can write a preparation log generated by the transaction participant 411 into a transaction buffer 1, and the transaction buffer 1 persistently stores the preparation log in the node A and other nodes on which slave replicas of the transaction participant 411 are deployed. Similarly, it is assumed that a master replica of a transaction participant 412 is deployed in a node B, and then the above-mentioned transaction status manager can write a preparation log generated by the transaction participant 412 into a transaction buffer 2, and the transaction buffer 2 persistently stores the preparation log in the node B and other nodes on which slave replicas of the transaction participant 411 are deployed.

However, as the quantity of transaction participants included in the target transaction increases and the quantity of replicas corresponding to each transaction participant increase, persistence efficiency of the above-mentioned preparation log decreases. The transaction participants 411 and 412 of the above-mentioned target transaction are used as an example. It is assumed that the master replica of the transaction participant 411 is deployed on the node A, and slave nodes of the transaction participant 411 are deployed on nodes B and C; the master replica of the transaction participant 412 is deployed on the node B, and slave nodes of the transaction participant 412 are deployed on the nodes A and C. In such case, after the transaction participant 411 and the transaction participant 412 write their respective preparation logs into the transaction buffers 1 and 2 by using the transaction status manager, the transaction buffers 1 and 2 each need to send the above-mentioned preparation logs to the nodes A, B, and C. In other words, the preparation logs of the transaction participants 411 and 412 generally need to be subject to six times of RPC for persistence to corresponding nodes (certainly, in the above-mentioned example, the transaction buffers 1 and 2 are respectively located exactly on the same node A as one replica of each of the transaction participants 411 and 412. Therefore, two times of RPC can be omitted additionally).

Since excessive times of RPC cause a great delay to the persistence process of the above-mentioned preparation logs, this specification further provides an optimization solution.

In some embodiments, master replicas of at least two transaction participants can be deployed on the above-mentioned master node, and slave replicas of the at least two transaction participants are deployed on at least one slave node of the one or more slave nodes. During persistence of preparation logs respectively generated by the at least two transaction participants, the master replicas of the at least two transaction participants can respectively send the preparation logs to the transaction status manager of the master node such that the transaction status manager writes the preparation logs into a target transaction buffer. The target transaction buffer persistently stores the preparation logs written by the at least two transaction participants in the corresponding master replicas respectively, and synchronizes the preparation logs in batches to the at least one slave node for persistence to the corresponding slave replicas. A difference between these embodiments and some above-mentioned embodiments lies in that the transaction status manager in these embodiments writes preparation logs generated by different transaction participants in the same node into the same transaction buffer (i.e., the above-mentioned target transaction buffer) such that the above-mentioned target transaction buffer can minimize the times of RPC through batch synchronization. FIG. 4 is still used as an example. These embodiments are equivalent to that the preparation logs of the transaction participants 411 and 412 are written together into the transaction buffer 1 by using the transaction status manager of the node A, and the transaction buffer 1 respectively writes the preparation logs of the transaction participants 411 and 412 into the master replicas or the slave replicas of the nodes A, B, and C. In other words, the preparation logs of the transaction participants 411 and 412 generally need to be subject to three times of RPC for persistence to the corresponding node (certainly, the transaction buffers 1 and 2 are respectively located exactly on the same node A as one replica of each of the transaction participants 411 and 412. Therefore, in these embodiments, only two times of RPC are actually needed), thereby greatly improving efficiency of persistently storing the preparation logs by the transaction participants. It can be understood by a person skilled in the art that, a premise for implementing these embodiments is to ensure that deployment statuses of replicas of a plurality of transaction participants on various nodes are identical (including completely identical and partially identical). Otherwise, the above-mentioned process of batch synchronization by the target transaction buffer is of no practical significance, and consequently, the times of RPC finally executed are the same as those in some above-mentioned embodiments.

3. The transaction participant returns a persistence result to the transaction coordinator.

After completing a persistence operation for the preparation log, the transaction participant can return the corresponding persistence result to the transaction coordinator.

4. The transaction coordinator initiates a corresponding transaction execution request to the transaction participant based on persistence results returned by all transaction participants for the preparation log.

It can be understood from the atomicity of the transaction that all transaction participants of the target transaction need to return the persistence result representing a success to the above-mentioned transaction coordinator such that the transaction coordinator can send a transaction commitment request with respect to the above-mentioned target transaction to all transaction participants. Once any transaction participant returns a persistence result representing a failure, or the preparation request is not successfully received or the persistence result is not successfully sent because of a network problem, the transaction coordinator needs to send a transaction rollback request with respect to the above-mentioned target transaction to all transaction participants. The above-mentioned transaction commitment request and the above-mentioned transaction rollback request are request types of the above-mentioned transaction execution request. Certainly, a condition for sending the transaction rollback request can be adjusted based on an actual situation. For example, when the transaction coordinator does not receive the preparation request or does not send a persistence result in a timely manner, the transaction coordinator can attempt to continuously inquire the transaction participant within predetermined retry duration until the transaction participant responds or an inquiry time exceeds the above-mentioned predetermined retry duration.

5. The transaction participant performs a transaction operation corresponding to the transaction execution request in response to the transaction execution request, and switches the target transaction from an unsettled state to a settled state after the execution is completed.

When the transaction participant receives the above-mentioned transaction commitment request, the transaction participant and the transaction coordinator do not need to persistently store the data similar to the above-mentioned commitment log, and the transaction participant only needs to perform the corresponding transaction commitment operation, and switch the target transaction from an unsettled state to a settled state by using a transaction sequence after the execution is completed. The transaction commitment operation can be releasing a lock and a resource that are used during processing of the target transaction. When the transaction participant receives the above-mentioned transaction rollback request, the transaction participant needs to generate and persistently store a transaction rollback log, perform a corresponding transaction rollback operation, and switch the target transaction from an unsettled state to a settled state after the execution is completed. The transaction rollback operation can include: releasing a lock used during processing of the target transaction after the above-mentioned persistence of the rollback log succeeds, and sending a rollback result representing a success/failure to the transaction coordinator. After receiving all rollback results representing a success, the transaction coordinator can notify all transaction participants to clean up the resources corresponding to the above-mentioned target transaction. It can be understood by a person skilled in the art that, the above-mentioned transaction participant does not need to persistently store the data similar to the commitment log. Therefore, the above-mentioned method can effectively shorten a lock holding time of the above-mentioned transaction participant, thereby improving system concurrency. In addition, the above-mentioned method can reduce a quantity of disk I/O times, thereby effectively reducing time consumption for transaction commitment.

The above-mentioned process of “switching from an unsettled state to a settled state” can represent that the transaction participant sets a transaction status of the target transaction in the corresponding transaction sequence to a settled state, or can represent an update operation for the demarcation location.

In some embodiments, the demarcation location is stored in a predetermined recording log. For example, as described above, the demarcation location can be the largest transaction version number of the successively committed transactions in the transaction sequence corresponding to the above-mentioned transaction participant. In such case, it is assumed that the above-mentioned transaction participant executes 10 transactions, such as a transaction t1, a transaction t2, a transaction t3, . . . , and a transaction t10, and these transactions are arranged in ascending order of the transaction version numbers. The transaction t1, the transaction t2, the transaction t3, and the transaction t5 are settled transactions, and the transaction t4 and the transactions t6 to t10 are unsettled transactions. In such case, the demarcation location is the version number corresponding to the transaction t3, and the above-mentioned recording log can record a latest version of the demarcation location. The above-mentioned recording log can persistently store the corresponding demarcation location based on methods of creating a file and writing, appending, or overwriting, which is not limited in this specification.

In some other embodiments, the demarcation location is stored in the preparation log. In comparison with a related technology, according to the solutions in this specification, although the above-mentioned commitment log is not persistently stored, system overheads caused by persistently storing the above-mentioned recording log periodically (for example, every 100 ms) still cannot be ignored. To reduce a quantity of times for persistence of the commitment log, in a process of committing a related transaction, each transaction participant can persistently store the largest transaction version number of the successively committed transactions in the current transaction sequence together with other log information directly in the above-mentioned preparation log.

In still some other embodiments, the demarcation location is stored in the predetermined recording log and the above-mentioned preparation log. In the process of generating the above-mentioned preparation log, the transaction participant records the demarcation location in the preparation log, and when frequency of performing a transaction operation is less than predetermined frequency, the transaction participant records the demarcation location in the recording log. In comparison with the above-mentioned two embodiments, in these embodiments, a part of the demarcation location is recorded in the recording log while ensuring that a quantity of times for persistence of the commitment log is reduced, thereby avoiding the following case: no new transaction is executed for a long time after the above-mentioned demarcation location is persistently stored in the preparation log, and consequently, a transaction version number of a settled transaction determined after the persistence of the above-mentioned preparation log is completed cannot be recorded in a timely manner.

In fact, this specification sets no limitation on an update timing of the demarcation location. The transaction participant can update the demarcation location while performing the transaction operation, or can update the demarcation location based on a transaction status of each corresponding transaction in the transaction sequence at a predetermined time point or after expiration of every predetermined time length.

The following further describes a function of the demarcation location recorded above when an abnormality occurs on the node on which the above-mentioned transaction participant is located and transaction restoration is performed.

In some embodiments, when an abnormality occurs and is recovered, the above-mentioned transaction participant can read and play back the persistently stored preparation log to restore a transaction in the above-mentioned transaction sequence, and then read and play back the persistently stored transaction rollback log to perform the above-mentioned transaction rollback operation on the corresponding transaction in the above-mentioned transaction sequence, and finally read the above-mentioned demarcation location, and perform a transaction commitment operation on a transaction preceding the above-mentioned demarcation location in the above-mentioned transaction sequence. There may be a case in which reading the above-mentioned transaction rollback log is missed. In such case, it can be determined that the above-mentioned transaction participant does not perform rollback on any transaction before the abnormality occurs. For example, as described above, these embodiments can also be interpreted based on a scenario of 10 transactions such as t1, t2, t3, . . . , and t10. When the above-mentioned transaction participant reads and plays back the persistently stored preparation log, the transactions t1, t2, t3, . . . , and t10 can be restored in the corresponding transaction sequence. In such case, when the above-mentioned transaction sequence does not record transaction statuses of these transactions, the transactions t1to t10 are all unsettled transactions. It is assumed that the transactions t1, t2, t3, and t5 are settled transactions, the transaction t4 and the transactions t6 to t10 are unsettled transactions, the above-mentioned transaction rollback log records a transaction rollback operation for the transaction t2, and the above-mentioned demarcation location is the version number corresponding to the transaction t3. In such case, the above-mentioned transaction participant can first perform a transaction rollback operation on the transaction t2, and after the rollback of the transaction t2 is completed, perform a transaction commitment operation directly on the transactions (i.e., the transactions t1 and t3) preceding the demarcation location in the transaction sequence. Up to now, the transaction restoration operation of the above-mentioned transaction participant is completed, and an entire transaction commitment procedure is subsequently executed again for other unsettled transactions (i.e., t6 to t10).

However, compared with the above-mentioned commitment log, the above-mentioned demarcation location can restore only most abnormal scenarios. For a special scenario, the transaction participant still cannot restore a transaction status of a corresponding transaction. For example, transaction commitment has been completed for all transactions in the active database. However, before a specific transaction participant persistently stores a corresponding demarcation location, active/standby switchover is performed, causing a slave node to be elected as a master node. In such case, a transaction participant on the new master node cannot determine a transaction status of a transaction in the active database. This specification introduces a technology with respect to a log identifier of a preparation log, so as to overcome a disadvantage of the above-mentioned demarcation location in a transaction restoration scenario.

In some embodiments, the transaction participant returns a log identifier of the preparation log corresponding to the target transaction in response to a pre-preparation request initiated by the transaction coordinator for the target transaction, so as to be added to a log identifier set included in the preparation request. In addition, the transaction participant adds the log identifier set of the transaction participant to the preparation log of the transaction participant in response to the received preparation request. The distributed database system includes a plurality of corresponding replicas for persistently storing the preparation log, and it is assumed that the plurality of replicas include a master replica and at least one slave replica. In such case, when switching between the master replica and the slave replica is performed, and a status of the target transaction on a new master replica is unknown, the new master replica can acquire, from the preparation log, a log identifier corresponding to another transaction participant except a transaction participant that the new master replica belongs to, and query, based on the acquired log identifier, a preparation log persistently stored by the another transaction participant for the target transaction. When all other transaction participants persistently store corresponding preparation logs, the new master replica can return a persistence result representing successful persistence to the transaction coordinator. Correspondingly, when any other transaction participants do not persistently store a corresponding preparation log, the new master replica can return a persistence result representing unsuccessful persistence to the transaction coordinator. The above-mentioned log identifier is used to uniquely identify a preparation log corresponding to a transaction participant. Certainly, according to different methods for generating the above-mentioned preparation log, the above-mentioned log identifier also has different meanings. For example, each transaction participant maintains only one preparation log file, and the preparation log file is assigned with a unique log identifier. All subsequent newly generated preparation logs can be appended to the end of the above-mentioned preparation log file. Alternatively, when generating a preparation log each time, each transaction participant creates one new preparation log file, and each created preparation log file is assigned with a unique log identifier. The above-mentioned preparation request includes log identifiers of all transaction participants in the above-mentioned target transaction. Therefore, for each slave replica with a preparation log played back, the log identifiers of the remaining transaction participants can be determined after the active/standby switchover. In addition, because of the atomicity of the transaction, if the remaining transaction participants each persistently store a preparation log describing any transaction, any transaction executed by a transaction participant after the active/standby switchover is bound to be a settled transaction. If the transaction rollback log that is played back includes no transaction rollback operation related to the above-mentioned any transaction, the transaction participant can return a persistence result representing successful persistence to the transaction coordinator. If any one of the remaining transaction participants does not persistently store a preparation log describing any transaction, a data operation corresponding to the transaction is not performed by all transaction participants. Therefore, any transaction executed by a transaction participant after the active/standby switchover is bound to be an unsettled transaction, and the transaction participant can return a persistence result representing unsuccessful persistence to the transaction coordinator.

On the basis of some above-mentioned embodiments, if the new master replica and any replica of the other transaction participants are located on the same node in the distributed database system, the above-mentioned new master replica can first query whether transaction status information of the target transaction is cached in a memory of the node on which the new master replica is located. If the query succeeds, the new master replica can restore, based on the transaction status information, a transaction status of the target transaction in a transaction sequence maintained by the new master replica. If the query fails, the new master replica can query, based on the acquired log identifier on the node on which the new master replica is located, the preparation log persistently stored by the another transaction participant for the target transaction. The memory of the same node records transaction status information of a corresponding transaction participant. Therefore, as long as the information is not cleared by the system, the new master replica can quickly restore, based on the information, the transaction status of the target transaction in the transaction sequence maintained by the new master replica. If the information is cleared, the above-mentioned transaction status can also be determined by using a log identifier.

It can be understood by a person skilled in the art that, although one time of RPC (i.e., an operation with respect to the above-mentioned pre-preparation request) is newly added to the solution in some above-mentioned embodiments, a delay caused in the transaction commitment process is still far less than time consumption for I/O of a plurality of times for persistently storing the transaction log in a related technology. Therefore, this solution can still be applied to a practical scenario.

The above-mentioned steps 1 to 4 successively correspond to steps 1 to 4 in FIG. 3, whereas step 5 is an operation of the above-mentioned transaction participant, and therefore is omitted in FIG. 3.

The above-mentioned transaction coordinator does not participate in the persistence operation of the transaction log, which is a major distinction in this specification. In other words, the above-mentioned transaction coordinator is stateless. Therefore, a corresponding status is designed in this specification for an abnormality such as restart upon shutdown that occurs on the above-mentioned transaction coordinator.

In some embodiments, when an abnormality occurs on the transaction coordinator, and is recovered, the above-mentioned transaction participant can resend the persistence result to the transaction coordinator such that the recovered transaction coordinator initiates a corresponding transaction execution request to all transaction participants based on the persistence results that are resent by the transaction participants. Certainly, in these embodiments, if an abnormality such as restart upon shutdown or active/standby switchover occurs on the above-mentioned transaction participant and the above-mentioned transaction coordinator at the same time, the transaction status of the transaction executed by the above-mentioned transaction participant can be first restored based on the above-mentioned solution, and then the transaction status of each transaction in the above-mentioned transaction coordinator is restored. For example, after a preparation phase for any transaction is completed, if restart upon shutdown occurs on all nodes, the coordinator cannot restore the original transaction status since the coordinator does not persistently store the corresponding transaction log. Therefore, after the transaction participant subsequently restores the transaction status, the transaction status of the transaction coordinator for the above-mentioned any transaction can be recreated such that the new coordinator continues to advance the transaction from the preparation phase until commitment of the above-mentioned any transaction is completed.

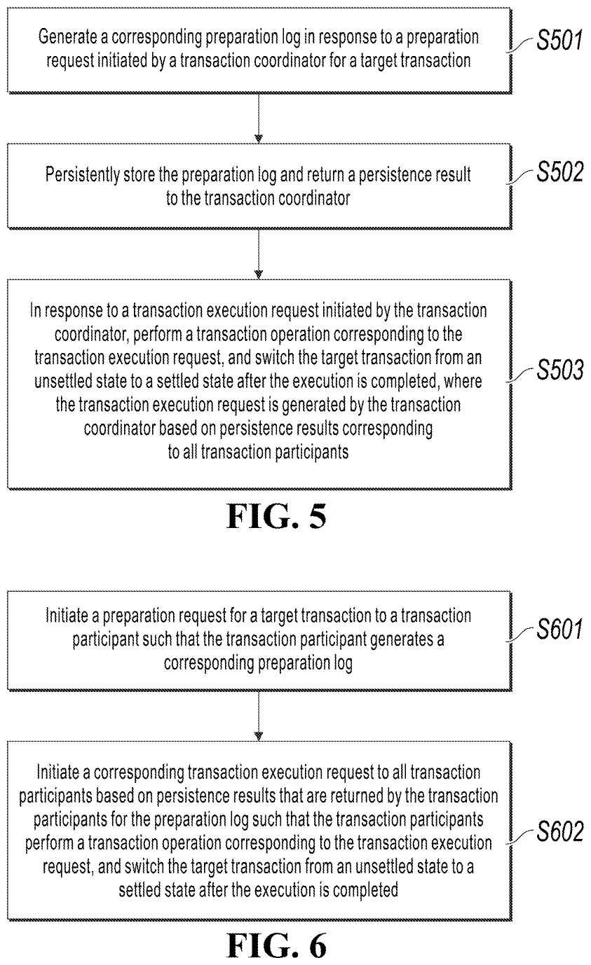

FIG. 5 is a schematic flowchart illustrating a transaction commitment method based on a distributed database system, according to some example embodiments of this specification. As shown in FIG. 5, the method is applied to transaction participants of a target transaction in the distributed database system. Each transaction participant records a demarcation location, and the demarcation location is used to represent that in a transaction sequence formed by transactions that are processed by corresponding transaction participants, transactions preceding the demarcation location are all in a settled state. The method includes:

S501: Generate a corresponding preparation log in response to a preparation request initiated by a transaction coordinator for the target transaction.

S502: Persistently store the preparation log and return a persistence result to the transaction coordinator.

S503: In response to a transaction execution request initiated by the transaction coordinator, perform a transaction operation corresponding to the transaction execution request, and switch the target transaction from an unsettled state to a settled state after the execution is completed, where the transaction execution request is generated by the transaction coordinator based on persistence results corresponding to all transaction participants.

As described above, the data maintained by the distributed database system include baseline data and incremental data generated for the baseline data, the baseline data are stored in a non-volatile memory, the incremental data are stored in a memory, and a transaction in the transaction sequence corresponds to the incremental data.

As described above, the transaction participant corresponds to a plurality of replicas in the distributed system, and the persistence of the preparation log by the transaction participant includes: the plurality of replicas each persistently store the preparation log; and the persistence result is correlated with a proportion of replicas with successful persistence in the plurality of replicas.

As described above, the distributed database system includes a master node and one or more slave nodes, a master replica of any transaction participant is deployed on the master node, a slave replica of the any transaction participant is deployed on the one or more slave nodes, the master replica is used for data access, and the slave replica is used for data backup; and the persistently storing the preparation log includes: sending, by the master replica, the preparation log to a transaction status manager of the master node such that the transaction status manager writes the preparation log into a corresponding transaction buffer; and persistently storing, by the transaction buffer, the written preparation log in the master replica and the slave replica.

As described above, master replicas of at least two transaction participants are deployed on the master node, and slave replicas of the at least two transaction participants are deployed on at least one slave node of the one or more slave nodes; and persistence of preparation logs respectively generated by the at least two transaction participants includes: respectively sending, by the master replicas of the at least two transaction participants, the preparation logs to the transaction status manager of the master node such that the transaction status manager writes the preparation logs into a target transaction buffer; and persistently storing, by the target transaction buffer, the preparation logs written by the at least two transaction participants in the corresponding master replicas respectively, and synchronizing the preparation logs in batches to the at least one slave node for persistence to the corresponding slave replicas.

As described above, the method further includes: returning a log identifier of the preparation log corresponding to the target transaction in response to a pre-preparation request initiated by the transaction coordinator for the target transaction, so as to be added to a log identifier set included in the preparation request; and adding the log identifier set to the preparation log in response to the received preparation request; the transaction participant corresponds to a plurality of replicas for persistently storing the preparation log in the distributed database system; and it is assumed that the plurality of replicas include a master replica and at least one slave replica; when switching between the master replica and the slave replica is performed, and a status of the target transaction on a new master replica is unknown, the new master replica acquires, from the preparation log, a log identifier corresponding to another transaction participant except a transaction participant that the new master replica belongs to, and queries, based on the acquired log identifier, a preparation log persistently stored by the another transaction participant for the target transaction; where: when all other transaction participants persistently store corresponding preparation logs, the new master replica returns a persistence result representing successful persistence to the transaction coordinator; or when any other transaction participants do not persistently store a corresponding preparation log, the new master replica returns a persistence result representing unsuccessful persistence to the transaction coordinator.

As described above, the new master replica and any replica of the another transaction participant are located on the same node in the distributed database system; and the querying, based on the acquired log identifier, a preparation log persistently stored by the another transaction participant for the target transaction includes: querying, by the new master replica, whether transaction status information of the target transaction is cached in a memory of the node on which the new master replica is located; and in response to that the query succeeds, restoring, by the new master replica based on the transaction status information, a transaction status of the target transaction in a transaction sequence maintained by the new master replica; or in response to that the query fails, querying, by the new master replica based on the acquired log identifier on the node on which the new master replica is located, the preparation log persistently stored by the another transaction participant for the target transaction.

As described above, the performing a transaction operation corresponding to the transaction execution request includes: performing a corresponding transaction commitment operation when the transaction execution request is a transaction commitment request; or generating and persistently storing a transaction rollback log and performing a corresponding transaction rollback operation when the transaction execution request is a transaction rollback request; and the method further includes: when an abnormality occurs and is recovered, reading and playing back the persistently stored preparation log to restore a transaction in the transaction sequence; reading and playing back the persistently stored transaction rollback log to perform the transaction rollback operation on the corresponding transaction in the transaction sequence; and reading the demarcation location and performing the transaction commitment operation on a transaction preceding the demarcation location in the transaction sequence.

As described above, the demarcation location is stored in a predetermined recording log and/or the preparation log.

As described above, the demarcation location is stored in the recording log and/or the preparation log, including: in a process of generating the preparation log, recording the demarcation location in the preparation log; and when frequency of performing a transaction operation is less than predetermined frequency, recording, by the transaction participant, the demarcation location in the recording log.

As described above, the transaction participant is further configured to: when an abnormality occurs on the transaction coordinator, and is recovered, resend the persistence result to the transaction coordinator such that the recovered transaction coordinator initiates a corresponding transaction execution request to all transaction participants based on the persistence results that are resent by the transaction participants.

FIG. 6 is a schematic flowchart illustrating another transaction commitment method based on a distributed database system, according to some example embodiments of this specification. As shown in FIG. 6, the method is applied to a transaction coordinator of a target transaction in the distributed database system, where the method includes:

S601: Initiate a preparation request for the target transaction to transaction participants such that the transaction participants generate a corresponding preparation log, where each transaction participant records a demarcation location, and the demarcation location is used to represent that in a transaction sequence formed by transactions that are processed by corresponding transaction participants, transactions preceding the demarcation location are all in a settled state.

S602: Initiate a corresponding transaction execution request to all transaction participants based on persistence results that are returned by the transaction participants for the preparation log such that the transaction participants perform a transaction operation corresponding to the transaction execution request, and switch the target transaction from an unsettled state to a settled state after the execution is completed.

As described above, the data maintained by the distributed database system include baseline data and incremental data generated for the baseline data, the baseline data are stored in a non-volatile memory, the incremental data are stored in a memory, and a transaction in the transaction sequence corresponds to the incremental data.

As described above, the transaction participant corresponds to a plurality of replicas in the distributed system, and the persistence of the preparation log by the transaction participant includes: the plurality of replicas each persistently store the preparation log; and the persistence result is correlated with a proportion of replicas with successful persistence in the plurality of replicas.

As described above, the method further includes: initiating a pre-preparation request for the target transaction to the transaction participant such that the transaction participant returns a log identifier of the preparation log corresponding to the target transaction, so as to be added to a log identifier set included in the preparation request; and initiating the preparation request to the transaction participant such that the transaction participant adds the log identifier set to the preparation log; the transaction participant corresponds to a plurality of replicas for persistently storing the preparation log in the distributed database system; and it is assumed that the plurality of replicas include a master replica and at least one slave replica; when switching between the master replica and the slave replica is performed, and a status of the target transaction on a new master replica is unknown, the new master replica acquires, from the preparation log, a log identifier corresponding to another transaction participant except a transaction participant that the new master replica belongs to, and queries, based on the acquired log identifier, a preparation log persistently stored by the another transaction participant for the target transaction; where: when all other transaction participants persistently store corresponding preparation logs, a persistence result representing successful persistence returned by the new master replica is received; or when any other transaction participants do not persistently store a corresponding preparation log, a persistence result representing unsuccessful persistence returned by the new master replica is received.

As described above, the demarcation location is stored in a predetermined recording log and/or the preparation log.

As described above, the method further includes: a third transaction restoration unit 904, configured to: when an abnormality occurs and is recovered, receive the persistence result resent by the transaction participant, and initiate a corresponding transaction execution request to all transaction participants based on the persistence results that are resent by the transaction participants.

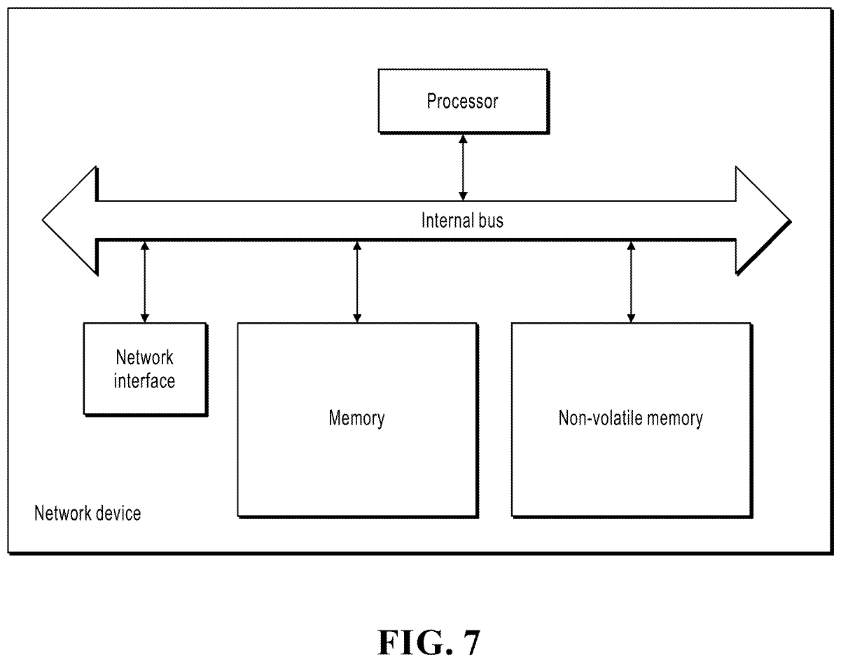

FIG. 7 is a schematic structural diagram illustrating an electronic device, according to some example embodiments. References are made to FIG. 7. At the hardware level, the electronic device includes a processor, an internal bus, a network interface, a memory, and a non-volatile memory, and certainly may further include other hardware needed. The processor reads a corresponding computer program from the non-volatile memory to the memory and then runs the computer program to form a transaction commitment apparatus based on a distributed database system at the logic level. Certainly, in addition to software implementations, this specification does not preclude other implementations, such as a logic device or a combination of software and hardware. In other words, an execution body of the following processing procedure is not limited to each logical unit, and can be hardware or a logic device.

Corresponding to some embodiments of the above-mentioned transaction commitment method based on a distributed database system, this specification further provides some embodiments of a transaction commitment apparatus based on a distributed database system.

It can be understood from some above-mentioned embodiments that, the transaction coordinator in this specification does not perform a persistence operation on the transaction log. In comparison with the conventional 2PC protocol, a quantity of disk I/O times is reduced, and overall time consumption for transaction commitment is reduced. In addition, the transaction participant does not need to persistently store the data similar to the commitment log. Therefore, a lock holding time of the transaction participant is shortened, thereby improving system concurrency. In addition, a quantity of disk I/O times is reduced, thereby effectively reducing time consumption for transaction commitment. In addition, introducing the demarcation location ensures that the transaction participant can implement a transaction restoration function after an abnormal state even without persistently storing the commitment log. Further, the transaction participant can restore the transaction status based on the log identifier, thereby overcoming a disadvantage of the demarcation location in a special situation.

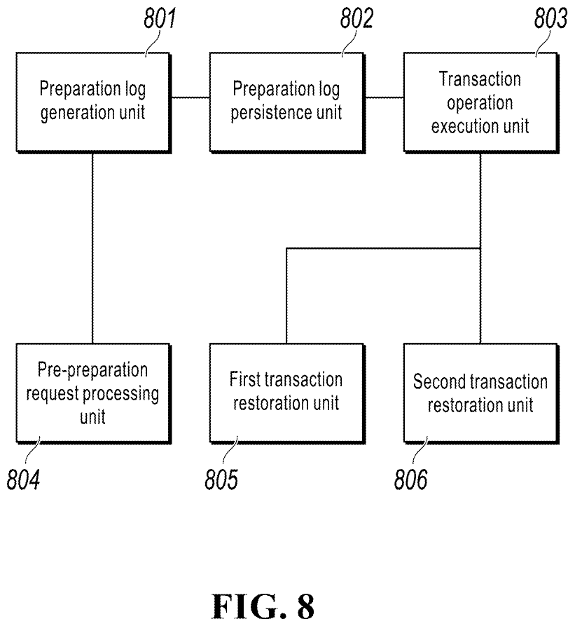

References are made to FIG. 8. FIG. 8 is a schematic structural diagram illustrating a transaction commitment apparatus based on a distributed database system, according to some example embodiments of this specification. As shown in FIG. 8, in some software implementations, the apparatus is applied to transaction participants of a target transaction in the distributed database system. Each transaction participant records a demarcation location, and the demarcation location is used to represent that in a transaction sequence formed by transactions that are processed by corresponding transaction participants, transactions preceding the demarcation location are all in a settled state. The apparatus includes: a preparation log generation unit 801, configured to generate a corresponding preparation log in response to a preparation request initiated by a transaction coordinator for the target transaction; a preparation log persistence unit 802, configured to persistently store the preparation log and return a persistence result to the transaction coordinator; and a transaction operation execution unit 803, configured to: in response to a transaction execution request initiated by the transaction coordinator, perform a transaction operation corresponding to the transaction execution request, and switch the target transaction from an unsettled state to a settled state after the execution is completed, where the transaction execution request is generated by the transaction coordinator based on persistence results corresponding to all transaction participants.

Optionally, the data maintained by the distributed database system include baseline data and incremental data generated for the baseline data, the baseline data are stored in a non-volatile memory, the incremental data are stored in a memory, and a transaction in the transaction sequence corresponds to the incremental data.

Optionally, the transaction participant corresponds to a plurality of replicas in the distributed system, and the persistence of the preparation log by the transaction participant includes: the plurality of replicas each persistently store the preparation log; and the persistence result is correlated with a proportion of replicas with successful persistence in the plurality of replicas.

Optionally, the distributed database system includes a master node and one or more slave nodes, a master replica of any transaction participant is deployed on the master node, a slave replica of the any transaction participant is deployed on the one or more slave nodes, the master replica is used for data access, and the slave replica is used for data backup; and the preparation log persistence unit 802 is specifically configured to: send, by the master replica, the preparation log to a transaction status manager of the master node such that the transaction status manager writes the preparation log into a corresponding transaction buffer; and persistently store, by the transaction buffer, the written preparation log in the master replica and the slave replica.

Optionally, master replicas of at least two transaction participants are deployed on the master node, and slave replicas of the at least two transaction participants are deployed on at least one slave node of the one or more slave nodes; and the preparation log persistence unit 802 is specifically configured to persistently store preparation logs respectively generated by the at least two transaction participants, including: respectively sending, by the master replicas of the at least two transaction participants, the preparation logs to the transaction status manager of the master node such that the transaction status manager writes the preparation logs into a target transaction buffer; and persistently storing, by the target transaction buffer, the preparation logs written by the at least two transaction participants in the corresponding master replicas respectively, and synchronizing the preparation logs in batches to the at least one slave node for persistence to the corresponding slave replicas.

Optionally, the apparatus further includes: a pre-preparation request processing unit 804, configured to return a log identifier of the preparation log corresponding to the target transaction in response to a pre-preparation request initiated by the transaction coordinator for the target transaction, so as to be added to a log identifier set included in the preparation request; and add the log identifier set to the preparation log in response to the received preparation request; the distributed database system includes a plurality of corresponding replicas for persistently storing the preparation log; and it is assumed that the plurality of replicas include a master replica and at least one slave replica; when switching between the master replica and the slave replica is performed, and a status of the target transaction on a new master replica is unknown, the new master replica acquires, from the preparation log, a log identifier corresponding to another transaction participant except a transaction participant that the new master replica belongs to, and queries, based on the acquired log identifier, a preparation log persistently stored by the another transaction participant for the target transaction; where: when all other transaction participants persistently store corresponding preparation logs, the new master replica returns a persistence result representing successful persistence to the transaction coordinator; or when any other transaction participants do not persistently store a corresponding preparation log, the new master replica returns a persistence result representing unsuccessful persistence to the transaction coordinator.

Optionally, the new master replica and any replica of the another transaction participant are located on the same node in the distributed database system; and the pre-preparation request processing unit 804 is specifically configured to: query, by the new master replica, whether transaction status information of the target transaction is cached in a memory of the node on which the new master replica is located; and in response to that the query succeeds, restore, by the new master replica based on the transaction status information, a transaction status of the target transaction in a transaction sequence maintained by the new master replica; or in response to that the query fails, query, by the new master replica based on the acquired log identifier on the node on which the new master replica is located, the preparation log persistently stored by the another transaction participant for the target transaction.

Optionally, the transaction operation execution unit 803 is specifically configured to: perform, by the transaction participant, a corresponding transaction commitment operation when the transaction execution request is a transaction commitment request; or generate and persistently store, by the transaction participant the transaction participant, a transaction rollback log and perform a corresponding transaction rollback operation when the transaction execution request is a transaction rollback request; and the apparatus further includes: a first transaction restoration unit 805, configured to: when an abnormality occurs and is recovered, read and play back the persistently stored preparation log to restore a transaction in the transaction sequence; read and play back the persistently stored transaction rollback log to perform the transaction rollback operation on the corresponding transaction in the transaction sequence; and read the demarcation location and perform the transaction commitment operation on a transaction preceding the demarcation location in the transaction sequence.

Optionally, the demarcation location is stored in a predetermined recording log and/or the preparation log.

Optionally, the demarcation location is stored in the recording log and the preparation log, and the preparation log generation unit 801 is specifically configured to: in a process of generating the preparation log, record the demarcation location in the preparation log; and when frequency of performing a transaction operation is less than predetermined frequency, record the demarcation location in the recording log.

Optionally, the apparatus further includes: a second transaction restoration unit 807, configured to: when an abnormality occurs on the transaction coordinator, and is recovered, resend the persistence result to the transaction coordinator such that the recovered transaction coordinator initiates a corresponding transaction execution request to all transaction participants based on the persistence results that are resent by the transaction participants.

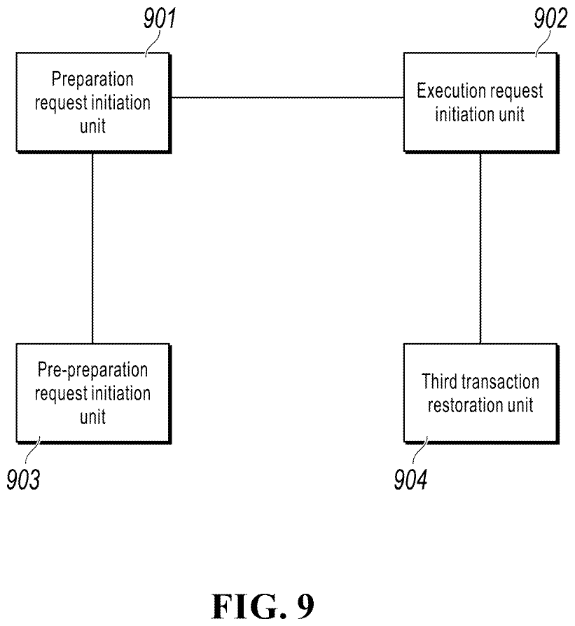

References are made to FIG. 9. FIG. 9 is a schematic structural diagram illustrating another transaction commitment apparatus based on a distributed database system, according to some example embodiments of this specification. As shown in FIG. 9, in some software implementations, the apparatus is applied to a transaction coordinator of a target transaction in the distributed database system, where the apparatus includes: a preparation request initiation unit 901, configured to initiate a preparation request for the target transaction to transaction participants such that the transaction participants generate a corresponding preparation log, where each transaction participant records a demarcation location, and the demarcation location is used to represent that in a transaction sequence formed by transactions that are processed by corresponding transaction participants, transactions preceding the demarcation location are all in a settled state; and an execution request initiation unit 902, configured to initiate a corresponding transaction execution request to all transaction participants based on persistence results that are returned by the transaction participants for the preparation log such that the transaction participants perform a transaction operation corresponding to the transaction execution request, and switch the target transaction from an unsettled state to a settled state after the execution is completed.

c

Optionally, the apparatus further includes: a pre-preparation request initiation unit 903, configured to initiate a pre-preparation request for the target transaction to the transaction participant such that the transaction participant returns a log identifier of the preparation log corresponding to the target transaction, so as to be added to a log identifier set included in the preparation request; and initiate the preparation request to the transaction participant such that the transaction participant adds the log identifier set to the preparation log; the transaction participant corresponds to a plurality of replicas for persistently storing the preparation log in the distributed database system; and it is assumed that the plurality of replicas include a master replica and at least one slave replica; when switching between the master replica and the slave replica is performed, and a status of the target transaction on a new master replica is unknown, the new master replica acquires, from the preparation log, a log identifier corresponding to another transaction participant except a transaction participant that the new master replica belongs to, and queries, based on the acquired log identifier, a preparation log persistently stored by the another transaction participant for the target transaction; where: when all other transaction participants persistently store corresponding preparation logs, a persistence result representing successful persistence returned by the new master replica is received; or when any other transaction participants do not persistently store a corresponding preparation log, a persistence result representing unsuccessful persistence returned by the new master replica is received.

Optionally, the demarcation location is stored in a predetermined recording log and/or the preparation log.

Optionally, the apparatus further includes: when an abnormality occurs and is recovered, receiving the persistence result resent by the transaction participant, and initiating a corresponding transaction execution request to all transaction participants based on the persistence results that are resent by the transaction participants.

For an implementation process of functions and roles of each unit in the apparatus, references can be made to an implementation process of corresponding steps in the above-mentioned method. Details are omitted here for simplicity.

Since some apparatus embodiments basically correspond to some method embodiments, for related parts, references can be made to related descriptions in the method embodiments. Some apparatus embodiments described above are merely examples. The units described as separate parts can be or do not have to be physically separate, and parts displayed as units can be or do not have to be physical units, that is, can be located in one position, or can be distributed on a plurality of network units. Some or all of the modules can be selected based on actual needs to achieve the objectives of the solutions of this specification. A person of ordinary skill in the art can understand and implement the solutions without creative efforts.

Some embodiments of the subject matters and function operations described in this specification can be implemented in the following: a digital electronic circuit, tangible computer software or firmware, computer hardware including a structure disclosed in this specification and structural equivalents thereof, or a combination of one or more of them. Some embodiments of the subject matters described in this specification can be implemented as one or more computer programs, i.e., one or more modules in computer program instructions that are encoded on a tangible non-transitory program carrier to be executed by a data processing apparatus or to control an operation of the data processing apparatus. Alternatively or additionally, program instructions can be encoded on an artificially generated propagation signal, such as an electrical, optical, or electromagnetic signal generated by a machine, and the signal is generated to encode and transmit information to an appropriate receiver apparatus for execution by the data processing apparatus. The computer storage medium can be a machine-readable storage device, a machine-readable storage substrate, a random or serial access memory device, or a combination of one or more of them.

The processing and logic procedures described in this specification can be executed by one or more programmable computers that execute one or more computer programs, so as to perform corresponding functions by performing operations based on input data and generating output. The processing and logic procedures can alternatively be executed by a dedicated logic circuit, such as a field-programmable gate array (FPGA) or an application-specific integrated circuit (ASIC), and the apparatus can also be implemented as a dedicated logic circuit.

Computers suitable for executing computer programs include, for example, general-purpose and/or dedicated microprocessors, or any other type of central processing unit. Generally, the central processing unit receives instructions and data from the read-only memory and/or the random access memory. Basic components of the computer include the central processing unit configured to implement or execute instructions and one or more memory devices configured to store instructions and data. Generally, the computer further includes one or more mass storage devices for storing data, such as a magnetic disk, a magneto-optical disk, or an optical disc, or the computer is operably coupled to the mass storage device to receive data from or transmit data to the mass storage device, or both of the two cases exist. However, the computer does not have to include such a device. In addition, the computer can be embedded into another device, for example, a mobile phone, a personal digital assistant (PDA), a mobile audio or video player, a game console, a global positioning system (GPS) receiver, or a portable storage device such as a universal serial bus (USB) flash drive.

The computer-readable medium suitable for storing computer program instructions and data includes all forms of non-volatile memories, media, and memory devices, including, for example, a semiconductor memory device (such as an EPROM, an EEPROM, and a flash memory device), a magnetic disk (such as an internal hard disk or a removable disk), a magneto-optical disk, a CD ROM, and a DVD-ROM. The processor and the memory can be supplemented by the dedicated logic circuit or incorporated into the dedicated logic circuit.

Although this specification includes many specific implementation details, these details should not be construed as limiting the scope of any invention or the scope of the claimed protection, but are mainly intended to describe features of some specific embodiments of a particular invention. Some features described in a plurality of embodiments in this specification can alternatively be implemented in combination in a single embodiment. In addition, the features described in a single embodiment can alternatively be implemented separately in a plurality of embodiments, or implemented in any appropriate sub-combination. In addition, although the features can take effect in some combinations and even initially claim protection as such, as described above, one or more features in the combinations sought to be protected can be removed from the combinations in some cases, and the combinations sought to be protected can point to sub-combinations or variants of the sub-combinations.

Similarly, although operations are depicted in a particular order in the accompanying drawings, it should not be understood as requiring these operations to be performed in the particular order shown, or performed successively, or requiring all illustrative operations to be performed to achieve the desired results. In some cases, multi-tasking and concurrent processing may be advantageous. In addition, separation of the system modules and components in some embodiments described above should not be understood as requiring such separation in all embodiments, and it should be understood that the described program components and systems can usually be integrated together in a single software product or encapsulated into a plurality of software products.

Therefore, some specific embodiments of the subject matters have been described. In addition, the processing depicted in the accompanying drawings is not necessarily performed in the particular order shown, or performed successively to achieve the desired results. In some implementations, multi-tasking and concurrent processing may be advantageous.

The above-mentioned descriptions are merely some example embodiments of this specification, but are not intended to limit this specification. Any modification, equivalent replacement, or improvement made without departing from the spirit and principle of this specification shall fall within the protection scope of this specification.

1. A distributed system, comprising a transaction coordinator and transaction participants of a target transaction, wherein each transaction participant of the transaction participants records a demarcation location, and the demarcation location indicates that in a transaction sequence formed by transactions processed by corresponding transaction participants, transactions preceding the demarcation location are in a settled state; wherein
the transaction coordinator is configured to:
initiate a preparation request for the target transaction to the transaction participant to cause the transaction participant to generate and persistently store a preparation log corresponding to the target transaction; and
initiate a transaction execution request corresponding to the target transaction to the transaction participant based on persistence results returned by the transaction participants for the preparation log; and wherein
the transaction participant is configured to:
generate a preparation log in response to the preparation request;
persistently store the preparation log;
return a persistence result to the transaction coordinator;
perform a transaction operation in response to the transaction execution request; and
switch the target transaction from an unsettled state to a settled state after the transaction execution is completed.

2. The system according to claim 1, wherein the transaction participant corresponds to a plurality of replicas in the distributed system, wherein persistently store the preparation log by the transaction participant comprises persistently store the preparation log for each of the plurality of replicas, and wherein the persistence result is associated with a percentage of replicas in the plurality of replicas that persistently storing the preparation log is successfully performed.

3. The system according to claim 2, further comprising a master node and one or more slave nodes, a master replica of the transaction participant is deployed on the master node, a slave replica of the transaction participant is deployed on the one or more slave nodes, the master replica is used for data access, and the slave replica is used for data backup; and wherein the persistently storing the preparation log comprises:
sending, by the master replica, the preparation log to a transaction status manager of the master node for the transaction status manager to write the preparation log into a transaction buffer; and
persistently storing, by the transaction buffer, the preparation log in the master replica and the slave replica.

4. The system according to claim 3, wherein master replicas of at least two transaction participants are deployed on the master node, and slave replicas of the at least two transaction participants are deployed on at least one slave node of the one or more slave nodes; and wherein persistently storing the preparation log comprises:
sending, by the master replicas of the at least two transaction participants, the preparation logs to the transaction status manager of the master node for the transaction status manager to write the preparation logs into a target transaction buffer;
persistently storing, by the target transaction buffer, the preparation logs written by the at least two transaction participants in the corresponding master replicas; and
synchronizing the preparation logs in batches to the at least one slave node to be persistently stored to the corresponding slave replicas.

5. The system according to claim 1, wherein
the transaction participant is further configured to:
in response to a pre-preparation request initiated by the transaction coordinator for the target transaction, return a log identifier of the preparation log corresponding to the target transaction for the log identifier to be added to a log identifier set comprised in the preparation request; and
add the log identifier set to the preparation log in response to the preparation request; wherein
the distributed system comprises a plurality of corresponding replicas for persistently storing the preparation log, wherein the plurality of replicas comprise a master replica and at least one slave replica; wherein
when switching between the master replica and the slave replica is performed, and a status of the target transaction on a new master replica is unknown, the new master replica acquires, from the preparation log, a log identifier corresponding to another transaction participant other than a transaction participant that the new master replica belongs to, and queries, based on the acquired log identifier, a preparation log persistently stored by the another transaction participant for the target transaction; wherein the new master replica indicates the transaction coordinator that persistently storing corresponding preparation logs are successfully performed when all other transaction participants persistently store the preparation logs.

6. The system according to claim 5, wherein the new master replica and a replica of the another transaction participant are located on a same node in the distributed system; and the querying, based on the log identifier, a preparation log comprises:
querying, by the new master replica, whether transaction status information of the target transaction is cached in a memory of the node on which the new master replica is located; and
in response to the querying being successful, restoring, by the new master replica based on the transaction status information, a transaction status of the target transaction in a transaction sequence maintained by the new master replica; or
in response to that the querying being unsuccessful, querying, by the new master replica based on the acquired log identifier on the node on which the new master replica is located, the preparation log persistently stored by the another transaction participant for the target transaction.

7. The system according to claim 1, wherein
the performing a transaction operation corresponding to the transaction execution request comprises:
performing, by the transaction participant, a corresponding transaction commitment operation when the transaction execution request is a transaction commitment request; or
generating and persistently storing, by the transaction participant, a transaction rollback log and performing a corresponding transaction rollback operation in response to determining that the transaction execution request is a transaction rollback request; and
the transaction participant is further configured to:
when an abnormality occurs and is recovered, reading and playing back the persistently stored preparation log to restore a transaction in the transaction sequence;
reading and playing back the persistently stored transaction rollback log to perform the transaction rollback operation on the corresponding transaction in the transaction sequence; and
reading the demarcation location and performing the transaction commitment operation on a transaction preceding the demarcation location in the transaction sequence.

8. The system according to claim 1, wherein the demarcation location is stored in a predetermined recording log or the preparation log.

9. The system according to claim 8, wherein the demarcation location is recorded in the preparation log during generation of the preparation log; and
wherein the demarcation location is in the predetermined recording log when frequency of performing a transaction operation is less than predetermined frequency.

10. The system according to claim 1, wherein the transaction participant is further configured to:
in response to determining that an abnormality occurs on the transaction coordinator and is recovered, resend the persistence results to the transaction coordinator for the recovered transaction coordinator to initiate a corresponding transaction execution request to all transaction participants based on the persistence results that are resent by the transaction participants.

11. A transaction commitment method performed by a distributed system, wherein the distributed system comprises a transaction coordinator and transaction participants of a target transaction, wherein each transaction participant of the transaction participants records a demarcation location, and the demarcation location indicates that in a transaction sequence formed by transactions processed by corresponding transaction participants, transactions preceding the demarcation location are in a settled state, and wherein the method comprises:
generating a preparation log in response to a preparation request initiated by a transaction coordinator for the target transaction;
persistently storing the preparation log;
returning a persistence result to the transaction coordinator;
in response to a transaction execution request initiated by the transaction coordinator, performing a transaction operation corresponding to the transaction execution request; and
switching the target transaction from an unsettled state to a settled state after the transaction execution is completed, wherein the transaction execution request is generated by the transaction coordinator based on persistence results corresponding to the transaction participants.

12. The method according to claim 11, wherein the transaction participant corresponds to a plurality of replicas in the distributed system, wherein persistently store the preparation log by the transaction participant comprises persistently store the preparation log for each of the plurality of replicas, and wherein the persistence result is associated with a percentage of replicas in the plurality of replicas that persistently storing the preparation log is successfully performed.

13. The method according to claim 12, wherein the distributed system comprises a master node and one or more slave nodes, a master replica of the transaction participant is deployed on the master node, a slave replica of the transaction participant is deployed on the one or more slave nodes, the master replica is used for data access, and the slave replica is used for data backup; and wherein the persistently storing the preparation log comprises:
sending, by the master replica, the preparation log to a transaction status manager of the master node for the transaction status manager to write the preparation log into a transaction buffer; and
persistently storing, by the transaction buffer, the preparation log in the master replica and the slave replica.

14. The method according to claim 13, wherein master replicas of at least two transaction participants are deployed on the master node, and slave replicas of the at least two transaction participants are deployed on at least one slave node of the one or more slave nodes; and wherein persistently storing the preparation log comprises:
sending, by the master replicas of the at least two transaction participants, the preparation logs to the transaction status manager of the master node for the transaction status manager to write the preparation logs into a target transaction buffer;
persistently storing, by the target transaction buffer, the preparation logs written by the at least two transaction participants in the corresponding master replicas; and
synchronizing the preparation logs in batches to the at least one slave node to be persistently stored to the corresponding slave replicas.

15. The method according to claim 11, wherein
the transaction participant is further configured to:
in response to a pre-preparation request initiated by the transaction coordinator for the target transaction, return a log identifier of the preparation log corresponding to the target transaction for the log identifier to be added to a log identifier set comprised in the preparation request; and
add the log identifier set to the preparation log in response to the preparation request; wherein
the distributed system comprises a plurality of corresponding replicas for persistently storing the preparation log, wherein the plurality of replicas comprise a master replica and at least one slave replica; wherein
when switching between the master replica and the slave replica is performed, and a status of the target transaction on a new master replica is unknown, the new master replica acquires, from the preparation log, a log identifier corresponding to another transaction participant other than a transaction participant that the new master replica belongs to, and queries, based on the acquired log identifier, a preparation log persistently stored by the another transaction participant for the target transaction; wherein the new master replica indicates the transaction coordinator that persistently storing corresponding preparation logs are successfully performed when all other transaction participants persistently store the preparation logs.

16. The method according to claim 15, wherein the new master replica and a replica of the another transaction participant are located on a same node in the distributed system; and the querying, based on the log identifier, a preparation log comprises:
querying, by the new master replica, whether transaction status information of the target transaction is cached in a memory of the node on which the new master replica is located; and
in response to the querying being successful, restoring, by the new master replica based on the transaction status information, a transaction status of the target transaction in a transaction sequence maintained by the new master replica; or
in response to that the querying being unsuccessful, querying, by the new master replica based on the acquired log identifier on the node on which the new master replica is located, the preparation log persistently stored by the another transaction participant for the target transaction.

17. The method according to claim 11, wherein
the performing a transaction operation corresponding to the transaction execution request comprises:
performing, by the transaction participant, a corresponding transaction commitment operation when the transaction execution request is a transaction commitment request; or
generating and persistently storing, by the transaction participant, a transaction rollback log and performing a corresponding transaction rollback operation in response to determining that the transaction execution request is a transaction rollback request; and
the transaction participant is further configured to:
when an abnormality occurs and is recovered, reading and playing back the persistently stored preparation log to restore a transaction in the transaction sequence;
reading and playing back the persistently stored transaction rollback log to perform the transaction rollback operation on the corresponding transaction in the transaction sequence; and
reading the demarcation location and performing the transaction commitment operation on a transaction preceding the demarcation location in the transaction sequence.

18. A non-transitory, computer-readable medium storing one or more instructions executable by a computer system to perform operations comprising:
generating a preparation log in response to a preparation request initiated by a transaction coordinator for a target transaction;
persistently storing the preparation log;
returning a persistence result to the transaction coordinator;
in response to a transaction execution request initiated by the transaction coordinator, performing a transaction operation corresponding to the transaction execution request; and
switching the target transaction from an unsettled state to a settled state after the transaction execution is completed, wherein the transaction execution request is generated by the transaction coordinator based on persistence results corresponding to transaction participants, wherein each transaction participant of the transaction participants records a demarcation location, and the demarcation location indicates that in a transaction sequence formed by transactions processed by corresponding transaction participants, transactions preceding the demarcation location are in a settled state.

19. The non-transitory, computer-readable medium according to claim 18, wherein the transaction participant corresponds to a plurality of replicas in a distributed system, wherein persistently store the preparation log by the transaction participant comprises persistently store the preparation log for each of the plurality of replicas, and wherein the persistence result is associated with a percentage of replicas in the plurality of replicas that persistently storing the preparation log is successfully performed.

20. The non-transitory, computer-readable medium according to claim 19, wherein the distributed system comprises a master node and one or more slave nodes, a master replica of the transaction participant is deployed on the master node, a slave replica of the transaction participant is deployed on the one or more slave nodes, the master replica is used for data access, and the slave replica is used for data backup; and wherein the persistently storing the preparation log comprises:
sending, by the master replica, the preparation log to a transaction status manager of the master node for the transaction status manager to write the preparation log into a transaction buffer; and
persistently storing, by the transaction buffer, the preparation log in the master replica and the slave replica.
